(19) United States
(12) Patent Application Publication
(10) Pub. No.: US 2018/0200654 A1
(43) Pub. Date: Jul. 19, 2018

(54) Non-Respirable Powdered Diatomaceous Earth Products

(71) Applicant: EP Minerals, LLC, Reno, NV (US)

(72) Inventors: Niels Steffen Mastrup, Reno, NV (US); Jonas Reid Pearce, Reno, NV (US); Scott Kevin Palm, Reno, NV (US); Chongjun Jiang, Rancho Cucamonga, CA (US); Qun Wang, Reno, NV (US); Bradley Scott Humphreys, Sparks, NV (US); George Asante Nyamekye, Sparks, NV (US); Peter E. Lenz, Reno, NV (US)

(73) Assignee: EP Minerals, LLC, Reno, NV (US)

(21) Appl. No.: 15/524,974

(22) PCT Filed: Dec. 11, 2015
(86) PCT No.: PCT/US2015/065329

§ 371 Date: May 5, 2017

Related U.S. Application Data
(60) Provisional application No. 62/094,810, filed on Dec. 19, 2014.
(60) Provisional application No. 62/131,054, filed on Mar. 10, 2015.

(51) Int. Cl. B01D 39/06; B65B 1/04; B65B 51/10; B65D 77/12

(52) U.S. Cl. CPC B01D 39/06; B65B 1/04; B65B 51/10; B01D 2239/0442; B01D 2239/10; B01D 2239/1241; B65D 77/12

(57) ABSTRACT

Disclosed is a non-respirable/substantially non-respirable product and method of manufacturing such product. The product may comprise diatomite having a median particle size distribution between about 10 microns and about 60 microns. The product is substantially non-respirable and may be enclosed inside a package wherein the product and inside the package have a combined aerobic bacterial count between about zero and about 114 (CFU/1.0 g). The product may have a dust number less than about 0.2.

### CROSS-REFERENCE TO RELATED PATENT APPLICATIONS

This patent application claims the benefit of U.S. Provisional Patent Application No. 62/094, 810, filed Dec. 19, 2014, and U.S. Provisional Patent Application No. 62/131, 054, filed Mar. 10, 2015.

### TECHNICAL FIELD

This disclosure relates to diatomite or diatomaceous earth (DE) for use as filter media in liquid filtration systems and in selected functional additive applications. More specifically, this disclosure relates to methods to manufacture and deliver a packaged non-respirable powdered diatomite product free of micro-organisms and suitable for storage and use for several years. The non-respirable diatomite is effective for filtering most liquids where diatomaceous earth products have traditionally been used and is also suitable for use in selected functional additive applications, such as in coatings, paper, and in certain radiation curable resin systems.

### BACKGROUND

Diatomite (diatomaceous earth) is sediment that includes silica in the form of siliceous skeletons (frustules) of diatoms. Diatoms are a diverse array of microscopic, single-celled, golden-brown algae generally of the class Bacillariophyceae that possess ornate siliceous skeletons of varied and intricate structures. Both the creation of the “inorganic” frustules by living organisms and the structures of the frustules are areas of significant interest to biologists. These structures vary considerably by species, but all contain submicron pores believed to have evolved to more efficiently process specific wavelengths of light for photosynthesis and to provide for buoyancy of the organism in lakes and oceans.

Because of these skeletal structures, diatomite is porous, permeable and useful as a filter aid for separating particles from liquids. Specifically, diatomite particles include voids that can fill with liquid and provide buoyancy to the particles when suspended in liquids. They can also physically entrap particles suspended in a liquid during a filtration process while permitting the liquid to pass through. Diatomite can also improve the clarity of liquids that exhibit turbidity or contain suspended particles or particulate matter. For example, the filters of swimming pools and spas often employ diatomite filter media in the form of a dry powder that includes fine or very small particles of diatomite and many food, beverage and chemical products, such as beer, wine, edible oils, sweeteners and lube oil additives are also filtered with diatomite filtration media.

While most inorganic naturally-occurring particulate materials can retain a small amount of liquid on the surface of the particles, diatomite is unusual in that it is capable of retaining a substantial amount of liquid internally within its pore structure. Many powdered diatomite products are produced through the process of milling the diatomite crude ore, drying, calcination, either in the presence of a flux or without a flux, dispersion of the calcined or flux calcined product and packaging of the resultant powder. The calcination and flux calcination processes can generate crystalline silica in the form of cristobalite, a mineral phase which may cause undesirable health effects when inhaled over time. Crystalline silica has been listed on the Special Health Hazard Substance List by OSHA, ACGIH, NIOSH, NTP and IARC.

Diatomite powder can have a fine particle size distribution, and, depending on the specific product, 50% of the material can be finer than about 10 to about 60 microns. When the internal void spaces of diatomite are filled with a light substance, such as a gas, they can become buoyant, airborne and respirable (able to be inhaled). While engineering controls are put in place in the manufacturing process to mitigate dust exposure and protect workers, and warning labels are provided on product packaging and other documents associated with the sale and use of the product, there is nevertheless a need for calcined and flux calcined diatomite products in which the fine particles containing potential crystalline silica phases cannot become airborne and, as a result, are not respirable (“non-respirable”) or are substantially not respirable (“substantially non-respirable”) by humans. For the purposes herein, substantially non-respirable by humans means a product that is about 95% to about 100% non-respirable by humans. Non-respirable means a product that is about 99.7% to 100% non-respirable.

Diatomite products used in many traditional applications, such as food and beverage filtration and in swimming pool applications and in many functional additive applications have traditionally been packaged in multilayer pasted valve paper bags to reduce the production of dust. Pasted valve paper bags are known in the art. Such bags are closed but have a pasted valve (typically, a sleeve with an opening) in a corner of the bag or elsewhere. During filling, the sleeve may be positioned around the outside of a spout. The opening in the sleeve is aligned over an aperture in the spout through which the powdered diatomite filter media is poured or metered by a spout packer, or the like (for example, gravity packer, impeller packer, air packer, screw packer or grooved belt packer). Ideally, the sleeve is contoured to closely fit around the spout in order to reduce the introduction of airborne particles into the surrounding environment during filling. After the bag is filled, the sleeve is tucked into the pasted valve paper bag to reduce spillage and dust generation. The pasted valve paper bag is not sealed. While this type of bag reduces dust generation during filling relative to open top bags, it can have a tendency to leak and to generate dust during shipping, transportation, and handling of the bag.

The inventors determined that an increase in the density of the particles of the diatomite can be achieved and that this can be effective in reducing the generation of dust and that such a modification is possible through the addition of a liquid while still allowing the product to be used in traditional applications. This increase in the density of the fine DE particles tends to make them less buoyant in air and less likely to become airborne when subjected to agitation or wind. With sufficient addition of a liquid, the particles may become non-respirable or substantially non-respirable by humans. However, several additional barriers to the technical application of this concept exist, including the following: (1) the growth of mold and other micro-organisms in the packaging; (2) the storage requirements for diatomite products, which can exceed 1-2 years or more; and (3) the liquid used to modify the density of the diatomaceous earth products must be compatible with the eventual liquid system in which the product will be employed, either as a filtration media or as a functional additive.

Diatomite filter aids became widely adopted in the filtration of sugar during the second decade of the Twentieth Century. Since that time, diatomite filtration media have become popular in the filtration of many liquids. Most of the liquids processed by diatomite filters involve products, such as beverages, food products, and chemicals, which are valued for their composition and purity. As a result, the common practice in the industry has been for diatomite filtration media to be sold and delivered to customers in a dry state: in other words, free of liquids within the internal pore structure. In addition, during the development of the industry and even to the current day, the most popular packaging material in the industry has been the paper bag. These have also been common practices of packaging diatomaceous earth products for use as functional additives.

As a result, the industry evolved principally to deliver dry, inert filtration media, free of contaminating liquids and other substances, packaged in paper bags to customers. Some product is also shipped in dry form or in bulk or, to a limited extent, in specialized packaging. For example, specialized packaging for diatomite products used as additives in plastics has been developed so that the material can be added to plastic master batches without removal from the package. However, in the addition of diatomite products to molten polymers, the absence of moisture in the diatomite is an important specification because the steam liberated from the interaction of a wet particle with the liquid plastic creates bubbles within the plastic. Such bubbles are unacceptable for polymer film applications, the largest use of diatomite in plastics.

In addition to the historic practices mentioned above, the end use applications of diatomite filtration very often cannot tolerate the introduction of micro-organisms into their products, as the presence of micro-organisms can lead to the contamination or spoilage of food, beverage and chemical products. The combination of paper, as food for micro-organisms, with water can often lead to the growth of micro-organisms. As a result, many company specifications and government regulations require that diatomite filtration media be delivered in a dry state for certain processes.

Due to a perceived lack of end use benefits for the delivery of damp or wet diatomite products, the industry has not developed a method to deliver damp, micro- organism-free diatomite filtration media to customers in durable packaging capable of long-distance shipment and storage. Packaged products of diatomite used in paint and in other functional additive applications have always been sold in dry form.

The nature of diatomite also poses some unusual or unique challenges for the shipment of a packaged product that contains moisture. The particles can contain up to approximately 70% moisture by weight within the internal pore structure, and this moisture can be released to form vapor through the application of heat or through a reduction of atmospheric pressure. The vapor so released can then be precipitated to liquid form if the temperature is reduced. Such changes in the difference in the internal pressure within the packages relative to the pressure outside of the package can result in a reduction in the integrity of the package, bag leakage or bag failure.

An additional challenge relates to the compatibility of any liquid introduced into the diatomaceous earth product with the final intended application of the product. Water, for example, is very compatible with the use of diatomaceous earth products in water-based systems, such as in the filtration of water in swimming pools and spas or in the use of diatomite products as a functional additive in latex-based paint systems. In certain other systems, water, may be compatible with a downstream system, such as beer, wine or other foods and beverages, if the amounts introduced by the filtration medium are well-known and are precisely controlled and if the water is free of micro-organisms and undesirable odor or taste.

On the other hand, a diatomaceous earth product containing water, even small quantities of water, may not be compatible with (1) certain systems in which the specifications or functionality of the liquid to be filtered cannot tolerate the addition of water (such as in the filtration of lube oil additives) or (2) solvent-based systems in which the diatomaceous earth product is used as a functional additive. However, alternative liquids are in most cases available that are compatible with most liquid systems, and these alternative liquids are in many cases suitable for use as de-dusting agents when used in filtration or functional additive applications. For the purposes herein, when a de-dusting agent used to modify the density of the diatomite filtration medium or functional additive is characterized as compatible, the term “compatible” means that the de-dusting agent is an acceptable ingredient in the liquid system (application), in an amount of about 0.01 wt % to about 10 wt % of the total liquid contained in such liquid system, in which the diatomite product will be suspended either in filtration or as a solid additive. In some embodiments, the de-dusting agent may be the same, or the same type of, liquid as the target liquid. In other embodiments, the de-dusting agent may be different than the target liquid.

### SUMMARY

In one aspect, a method for manufacturing low dust, substantially non-respirable or non-respirable diatomaceous earth products is disclosed. Such a product may be a filter medium. The disclosed method may include providing diatomite or diatomite ore and calcining the diatomite, either in the presence of a flux or without a flux, and classifying the calcined or flux calcined diatomite powder to provide the diatomite filter medium with permeability of about 0.1 to about 10 darcy. In an embodiment, calcining or flux calcining diatomite provides calcined or flux calcined diatomite powder having particles of a median particle size of about 10 to about 60 microns. The method may further include classifying the calcined or flux-calcined diatomite powder to provide the diatomite filter medium. The method may further include spraying a de-dusting agent comprising a liquid compatible with the expected downstream use of the product (compatible with the liquid system and the target liquid that will be filtered or compatible with the liquid system to which a functional additive will be incorporated) onto the diatomite filter medium while fluidizing the diatomite filter medium to obtain a uniform distribution of de-dusting agent in the powder to provide a pretreated diatomite filter medium. In one embodiment the de-dusting agent may be water. In another embodiment, the de-dusting agent may comprise water. In an embodiment, the de-dusting agent may be a polar or non-polar liquid that is compatible with the liquid that will be filtered or with the liquid system to which a functional additive will be incorporated. In another embodiment, the de-dusting agent may be hydrophilic or hydrophobic. The pretreated diatomite filter medium is then packaged in packaging that is impermeable to the liquid de-dusting agent.

In another aspect, a particulate filter medium for spas and swimming pools and for clarifying food, beverages and chemicals is disclosed. The particulate filter medium may include natural, calcined or flux calcined diatomite particles having 90% of the particle size greater than 10 microns, from about 5 to about 25 wt % de-dusting agent. In one embodiment the de-dusting agent may comprise water and at least about 0.5 ppm sodium hypochlorite. Further, the calcined or flux calcined diatomite particles, water and sodium hypochlorite may be contained within a re-sealable, water-impermeable package. In any one or more of the embodiments described above, the water may be purified water. In another embodiment, the de-dusting agent may comprise water or may comprise another polar or non-polar liquid that is compatible with the intended product to be filtered.

In yet another aspect, a method of manufacturing a low dust diatomaceous earth product, for example a filter medium, containing less than 100 microorganism count is disclosed. The method may comprise calcining or flux calcining diatomite to provide calcined or flux calcined diatomite particles, fluidizing the diatomite product and spraying water onto the diatomite product during fluidization of the diatomite product to provide a pre-treated, non-respirable/substantially non-respirable diatomite product (such as filter media), and packaging the non-respirable/substantially non-respirable diatomite product in a water-impermeable package suitable for storage of the product for at least two months. In an embodiment, the package and product may be suitable for storage for at least four months. In another embodiment, the package and product may be suitable for storage for at least six months.

In yet another aspect, a packaged product is disclosed. In an embodiment, the product comprises natural, calcined or flux calcined diatomite having a median particle size distribution between about 10 microns and about 60 microns, wherein the product is non-respirable/substantially non-respirable and is enclosed inside a package, wherein the product and inside the package have a combined aerobic bacterial count between about zero and 114 (CFU/1.0 g), and the product has a dust number less than about 0.2. Also disclosed is a method of using such packaged product in a filtration or a functional additive application.

In any one or more of the embodiments described above, the de-dusting agent may comprise water or another polar or non-polar liquid. In any one or more of the embodiments described above, the de-dusting agent may include an antimicrobial agent. In any one or more of the embodiments described above, the de-dusting agent may comprise water and an antimicrobial agent. In any one or more of the embodiments described above, the antimicrobial agent may be selected from the group consisting of chlorine dioxide, sodium hypochlorite, calcium hypochlorite, sodium dichloroisocyanurate and combinations thereof.

In any one or more of the embodiments above, before spraying the de-dusting agent onto the diatomite product, the de-dusting agent may be sanitized by exposing the de-dusting agent to a form of energy or irradiation that may be selected from the group consisting of ultraviolet light, dielectric barrier discharge (DBD) plasma, gamma rays, and any form of thermal treatment in which the temperature of the de-dusting agent is raised above 100 degrees Celsius.

In any one or more of the embodiments described above, prior to spraying the de-dusting agent onto the diatomite product (e.g. filter media), the de-dusting agent may be subjected to at least one of micro-filtration and ultrafiltration.

In any one or more of the embodiments described herein, the package may be a liquid-impermeable bag that is re-sealable. In any one or more of the embodiments described herein, the package may be a thermally sealed. In any one or more of the embodiments described herein, the package may be vertically filled.

In any one or more of the embodiments described above, the bag may be fabricated from a polymeric material that may be selected from the group consisting of one or more polyesters, polyamides, polypropylenes, cellophanes, polyvinyl chlorides, polyvinylidene fluorides, polyvinylidene chlorides, polyimides, polyethylenes and combinations thereof.

In any one or more of the embodiments described above, the non-respirable/substantially non-respirable diatomite product (e.g. a filter medium) may include less than 100 microorganisms using a viable count method selected from the group consisting of pour plating, spread plating, a most probable number method and combination thereof.

In any one or more of the embodiments described above, the non-respirable/substantially non-respirable diatomite product (e.g., a filter medium) may include less than 10 microorganisms using a viable count method selected from the group consisting of pour plating, spread plating, a most probable number method and combinations thereof.

In any one or more of the embodiments described above, the non-respirable/substantially non-respirable diatomite product (e.g., a filter medium) may include from about 4 wt % to about 70 wt % de-dusting agent.

In any one or more of the embodiments described above, the non-respirable/substantially non-respirable diatomite product (e.g., a filter medium) may include from about 4 wt % to about 60 wt % de-dusting agent.

In any one or more of the embodiments described above, the non-respirable/substantially non-respirable diatomite product (e.g., a filter medium) may include from about 5 wt % to about 50 wt % de-dusting agent.

In any one or more of the embodiments described herein, the de-dusting agent may include from about 5 to about 500 ppm sodium hypochlorite.

In any one or more of the embodiments described above, the de-dusting agent may include from about 5 to about 50 ppm sodium hypochlorite.

In any one or more of the embodiments described above, the liquid-impermeable package may be a re-sealable bag fabricated from at least one synthetic paper.

In any one or more of the embodiments described above, the liquid-impermeable package may include an outer paper shell lined with a water-impermeable barrier layer.

In one embodiment the non-respirable/substantially non-respirable diatomite product may be treated following packaging through exposure of the packaged product to gamma irradiation or other forms of radiation known to be effective in the sterilization of food, pharmaceutical, chemical and other organic and inorganic products and materials.

In any one or more of the embodiments described above, the product may be a filter medium or a functional additive for a target liquid in a liquid system, and the de-dusting agent may be compatible, in the liquid system, with the target liquid.

In any one or more of the embodiments described above, the product may have a Chlorophyll A content that is less than about 47 (μg/L). In any one or more of the embodiments described above, the product may have a Chlorophyll A content that is between about zero and about 2 (μg/L).

In any one or more of the embodiments described above, the package in which the product is enclosed may be a bag made of a material having an MVTR in the range of about 20 g/0.065 m²/24 hours to about 0 g/0.065 m²/24 hours, as determined by using a standard test method selected from the group consisting of ASTM F1249-06, ASTM E398-03, ASTM D3079, ASTM D7709, ASTM E96, and ASTM F1249.

### DETAILED DESCRIPTION

This application discloses methods for preparing and delivering a diatomaceous earth or a diatomite product, such as a diatomite filter medium/media. The diatomite product is pretreated so that it is hygienic, mold free and, at least, substantially dustless and non-respirable/substantially non-respirable during subsequent handling, storage and use. The non-respirable/substantially non-respirable diatomite products disclosed herein are suitable for storage of at least one year and preferably for as long as five years. Such products may be in powder form. Non-respirable and substantially non-respirable diatomite filter media products for pools and spas and traditional food, beverage and chemical filtrations and non-respirable and substantially non-respirable diatomite products such as functional additives are disclosed. The disclosed methods utilize at least one de-dusting agent that dramatically reduces or eliminates diatomite dust and thus renders the diatomite product substantially non-respirable or non-respirable. This is beneficial during material handling practices such as packaging, re-packaging, shipping, and transportation of the non-respirable/substantially non-respirable diatomite product (e.g., filter media), as well as during the use of the pretreated diatomite product in liquid systems, such as those for filtration of swimming pools and spas and in other traditional applications of diatomite filtration media, as well as additives in coatings, paper and selected structural products. The de-dusting agent is added to calcined diatomite particles that have been classified to achieve the permeability required for filtration applications or the particle size required for functional additive applications.

Because of the small particle size and light density, the calcined diatomite particles are buoyant in air and therefore normal handling of a resulting diatomite product (e.g., filter media) may create diatomite dust, which can potentially be inhaled by humans.

To avoid the dust problem, and to render the product substantially non-respirable or non-respirable, the diatomite filter medium may be wetted or pretreated with a de-dusting agent, such as water or another de-dusting agent prior to packaging, which reduces the buoyancy of the diatomite particles in air. While the substantially non-respirable or non-respirable diatomite product may generate a very tiny amount of dust during handling, for instance, when either opening or closing the packaging or when pouring the substantially non-respirable or non-respirable diatomite product from the package, the substantially non-respirable or non-respirable diatomite product is a nearly dustless product that may be packaged in such a way that the de-dusting agent is not lost during storage.

One suitable package for the substantially non-respirable or non-respirable diatomite product, includes, but is not limited to, moisture-impermeable bags or containers, which may be re-closable bags or containers or single-use bags or containers. In one embodiment, the package may be water-impermeable. In an embodiment, such package may include an outer paper shell lined with a water-impermeable barrier layer. In other embodiments, other suitable water-impermeable packages and packages that are impermeable to other liquids may be used.

One embodiment of the de-dusting agent may consist of water. In another embodiment, the de-dusting agent may consist of purified water. In yet another embodiment, the de-dusting agent may include water or purified water. To prevent mold and other microorganisms from contaminating the diatomite product (e.g., filter medium), the de-dusting agent may include water (or purified water) and an anti-microbial agent, such as at least one of chlorine, chlorine dioxide, sodium hypochlorite, calcium hypochlorite, sodium dichloroisocyanurate etc., and combinations thereof. In some embodiments, the de-dusting agent may also be purified prior to use to remove micro-organisms using micro-filtration or ultra-filtration techniques. Further, the water or other de-dusting agent may be sanitized through exposure to ultraviolet (UV) light, dielectric barrier discharge (DBD) plasma, gamma rays or combinations thereof, as well as by raising the temperature of the de-dusting agent above 100 degrees Celsius. Gamma irradiation may be applied to either the de-dusting agent or the diatomite prior to the application of the de-dusting agent or it may be applied to the packaged pretreated diatomite product (after the application of the de-dusting agent and following packaging). In addition, steam or other thermal treatments may also be used to sanitize the product. In an embodiment, the substantially non-respirable or non-respirable diatomite product may include less than 100 microorganisms using a viable count method selected from the group consisting of pour plating, spread plating, a most probable number method and combinations thereof. In another embodiment, the pretreated diatomite filter medium may include less than 10 microorganisms using a viable count method selected from the group consisting of pour plating, spread plating, a most probable number method and combinations thereof.

One disclosed method for manufacturing a substantially non-respirable or non-respirable diatomite product (e.g., filter medium, additive, or the like) may include: (1) thermally sintering or calcining natural diatomite ore, optionally in the presence of a flux, to provide calcined diatomite particles or, optionally, flux calcined diatomite particles having various particle sizes, for example, the median particle size may be in the range of about 10 to about 60 microns; (2) dispersing the calcined diatomite particles and classifying the particles to conform to the particle size distribution of a filtration medium (in other embodiments, the particle size distribution of the desired additive, or the like); (3)(a) optionally, purifying a de-dusting agent, for example water, by micro-filtration and/or ultrafiltration or (3)(b) optionally, sanitizing a de-dusting agent, for example water, by adding an antimicrobial agent to the de-dusting agent, wherein the antimicrobial agent may be selected from the group consisting of chlorine dioxide, sodium hypochlorite, calcium hypochlorite, sodium dichloroisocyanurate, and combinations thereof, and/or (3)(c) optionally, exposing a de-dusting agent, (for example, water) to a form of radiation or energy sufficient to kill microorganisms, wherein the form of radiation or energy may be selected from the group consisting of ultraviolet light, dielectric barrier discharge (DBD) plasma, gamma rays and combinations thereof and/or (3)(d) sanitizing the de-dusting agent and product through thermal treatments such as steam addition; (4) conveying the diatomite (filter medium, additive or the like) resulting from the classifying to a mixer, blender or agitator (e.g., a ribbon blender) and agitating the diatomite (filter medium, additive or the like); (5) spraying the diatomite (filter medium, additive, or the like) with a predetermined dose of the de-dusting agent, purified de-dusting agent and/or the sanitized de-dusting agent (e.g. sanitized water) of part (3) above while agitating the diatomite (filter medium, additive or the like) to produce a pretreated diatomite product such as a filter medium, additive or the like; (6) optionally, packaging the substantially non-respirable or non-respirable diatomite product (filter medium, additive or the like) in a moisture-impermeable or de-dusting agent impermeable package, that may optionally be re-closeable; and (7) optionally, exposing the packaged substantially non-respirable or non-respirable diatomite product (filter medium, additive, or the like) to gamma radiation or thermal treatment. The substantially non-respirable or non-respirable diatomite product (filter medium, additive, or the like) may, in one embodiment, have a permeability of about 1 to about 10 darcy. In another embodiment, the substantially non-respirable or non-respirable diatomite product (filter medium, additive, or the like) may have a permeability of about 2 to about 8 darcy. The substantially non-respirable or non-respirable diatomite product may be a powder.

Agitation of the diatomite product fluidizes the powdered diatomite filter medium or additive by levitating the particles of the diatomite filter medium (or additive) into a dense phase suspension. Alternatively, fluidizing of the powdered diatomite product (filter medium, additive, or the like) may be achieved by suspending such in a stream of air (dilute phase).

The spraying of the diatomite product (filter medium, additive, or the like) with the de-dusting agent, purified de-dusting agent and/or sanitized de-dusting agent may be continued until the predetermined desired dosage is reached and/or until the de-dusting agent, purified de-dusting agent or sanitized de-dusting agent is uniformly mixed with the diatomite product and the agitation of the diatomite product no longer creates dust. The non-respirable/substantially non-respirable diatomite product (filter medium, additive, or the like) may be packaged in packages (e.g. containers, bags or the like) which are optionally water or de-dusting agent impermeable and/or re-sealable.

The chemistry of a typical fresh water diatomite feedstock as measured by X-ray fluorescence (XRF) is shown in Table I.

TABLE I
Chemical Composition of Diatomite Feed Examples - XRF (Ignited
Basis)

| | SiO₂ % | Al₂O₃ % | CaO % | MgO % | Na₂O % | K₂O % | Fe₂O₃ % | TiO₂ % |
|---|---|---|---|---|---|---|---|---|
| Fresh | 94.01 | 2.72 | 0.63 | 0.28 | 0.37 | 0.23 | 1.50 | 0.11 |
| Water | | | | | | | | |
| Diatomite | | | | | | | | |

Flux Calcination: The diatomite ore (natural diatomite) may be calcined, preferably in the presence of a fluxing agent. The flux calcination may be conducted in a conventional manner in a gas-fired rotary kiln at temperatures ranging from about 1800° F. to about 1900° F. (˜980° C.-1040° C.) to produce flux calcined diatomite particles having particle sizes in the range of up to about 500 microns, preferably mostly in the range of about 5 microns to about 500 microns. Alternatively, the diatomite ore (natural diatomite) may be calcined without a fluxing agent. Such calcination may be conducted in a conventional manner in a gas burned rotary kiln at temperatures ranging from about 1800° F. to about 2000° F. (˜980° C.-1093° C.) to produce calcined diatomite particles having particle sizes in the range of up to about 500 microns, preferably in the range of about 5 microns to about 500 microns.

In one embodiment, the calcined or flux calcined, diatomite particles may have a median particle size in the range of about 10 microns to about 60 microns. In another embodiment, the calcined or flux calcined diatomite particles may have a median particle size of about 45 microns. Other means of calcining, or flux calcining, diatomite are available and will be apparent to those skilled in the art.

Dispersion and Classification: After the flux calcination or calcination is complete, the kiln discharge may be dispersed by high speed milling fans and may be classified to specific particle size fractions through a series of cyclones and screeners or sieves, connected with a finish end baghouse for fine collection. As will be apparent to those skilled in the art, an acceptable size range for the diatomite particles may vary, and will depend upon the application or end use.

De-dusting/Pretreatment: The de-dusting agent may be metered through a sprayer bar or other device that is suitable for dispersing or spraying such de-dusting agent. Optionally, a flow meter may be used to monitor or control the amount of de-dusting agent used. The de-dusting agent may be purified using known micro-filtration or ultrafiltration techniques. The de-dusting agent may also be pretreated by UV radiation, DBD plasma, gamma rays, thermal treatment or combinations thereof, and/or the de-dusting agent may optionally contain at least one antimicrobial agent such as chlorine dioxide, sodium hypochlorite, calcium hypochlorite, sodium dichloroisocyanurate, and combinations thereof. For example, the de-dusting agent may include water and at least one antimicrobial agent such as chlorine dioxide, sodium hypochlorite, calcium hypochlorite, sodium dichloroisocyanurate, and combinations thereof.

The agitation may be stopped only after a predetermined dose of the de-dusting agent (e.g. water or water/antimicrobial) is applied to the diatomite product to produce the substantially non-respirable/non-respirable diatomite filter medium. The substantially non-respirable/non-respirable diatomite product may also be treated through exposure to gamma irradiation and/or thermal treatment while disposed inside its packaging.

In one embodiment, the substantially non-respirable or non-respirable diatomite product (filter medium, additive or the like) may include from about 4 to about 75 wt % de-dusting agent, from about 4 wt % to about 70 wt % de-dusting agent, from about 4 wt % to about 60 wt % de-dusting agent, from about 5 wt % to about 50 wt % de-dusting agent, or from about 10 wt % to about 15 wt % de-dusting agent. In an embodiment in which the de-dusting agent is water, the substantially non-respirable or non-respirable diatomite product may include from about 4 wt % to about 75 wt % water, from about 4 wt % to about 70 wt % water, from about 4 wt % to about 60 wt % water, from about 5 wt % to about 50 wt % water, or from about 10 wt % to about 15 wt % water.

As discussed earlier herein, some substantially non-respirable or non-respirable diatomaceous earth products may be used to filter liquids for which water may not be a suitable ingredient (for example, lube oil additives or the like). Thus, in some embodiments, the substantially non-respirable or non-respirable diatomaceous earth product may comprise diatomite, and a de-dusting agent that is an appropriate (compatible) liquid ingredient in the liquid system application (in an amount of about 0.01 wt % to about 10 wt % of the total liquid contained in such liquid system that is subject to the filtration. For example, in the case of the filtration of a petroleum-based product or a substitute for a petroleum-based product, such as diesel fuel or biodiesel, a compatible de-dusting agent may be a petroleum-based product or substitute, such as diesel fuel or biodiesel or, alternatively, certain vegetable oils. In the filtration of a vegetable oil, such as a palm oil or peanut oil, then the product oil (palm or peanut oil) may be a compatible de-dusting agent. In the case of certain alcoholic beverages, such as beer or wine, water may be a suitable compatible de-dusting agent.

Similarly, some substantially non-respirable or non-respirable diatomaceous earth products may be used as functional additives in coatings in which various liquid carriers are employed, such as water for latex systems or organic solvents for solvent or oil-based paints. Selected organic solvents which are compatible with solvent-based paints include aliphatics, aromatics, alcohols, ketones, white spirit, petroleum distillate, esters and glycol ethers. Each of these organic solvents is an appropriate compatible de-dusting agent for use for diatomite functional additives, depending on the formulation of the solvent-based paint to which the diatomite functional additive will be incorporated. The table below shows some examples of diatomite applications and the corresponding compatible de-dusting agents.

| Diatomite Application | Compatible De-Dusting Agent Example |
|---|---|
| Oil paint filler | oils, for example. linseed oil |
| Plastic/rubber filler | pthalates, ex. di(2-ethylhexyl) phthalate (DEHP) |
| Latex paint filler | alcohols, ex. trexanol, ethanol, propylene glycol |
| Polymer filtration/filler | polymers, ex. Polytetramethylene Ether Glycol |
| | (PTMEG) |
| Edible oil filtration | corn, soybean, canola oils |

As a further example, if the diatomite functional additive were to be used as a functional additive in an ultraviolet-cured or electron-beam cured system, it may be appropriate to employ a photopolymer that is compatible as an ingredient in such system as a de-dusting agent. Possible de-dusting agents in this case would include photopolymer oligomers, such as expoxides, urethanes, and polyethers or photopolymer monomers, such as styrene, n-vinylpyrrolidine, and acrylates.

The percent moisture of the de-dusting agent is calculated on the relative weights of the diatomite product and the de-dusting agent. To determine the percent moisture on a weight basis, about 10 g of the sample is placed in a crucible that has been accurately weighed (Wₒ). The crucible and sample are weighed (WO and are then place in a drying oven that is set at 106° C. Drying continues until constant weight is attained. The sample is cooled in a desiccator and the weight of the crucible and sample is measured again (W₂).

The percent moisture (weight basis) is calculated as:

Weight % Moisture=100*[1−(W₂−Wₒ)/(W₁−Wₒ)]

In another embodiment, the de-dusting agent may include water and from about 5 to about 500 ppm sodium hypochlorite. In yet another embodiment, the de-dusting agent may include water and from about 5 to about 50 ppm sodium hypochlorite. In an embodiment, the substantially non-respirable or non-respirable diatomite product (e.g. filter medium, additive or the like) may include calcined or flux calcined diatomite particles having particles sizes in a range of about 5 microns to about 500 microns. In another embodiment, the substantially non-respirable or non-respirable diatomite product may include calcined or flux calcined diatomite particles having particles sizes in a range of about 5 microns to less than 45 microns. In an embodiment, the substantially non-respirable or non-respirable diatomite product may have calcined or flux calcined diatomite particles having a median particle size in a range of about 10 microns to about 60 microns. In another embodiment, the substantially non-respirable or non-respirable diatomite product may have calcined or flux calcined diatomite particles having a median particle size in a range of about 30 microns to about 60 microns. In yet another embodiment, the substantially non-respirable or non-respirable diatomite product may have calcined or flux calcined diatomite particles having a median particle size about 45 microns.

In another embodiment, the substantially non-respirable or non-respirable diatomite product (e.g. filter medium, additive, or the like) may include calcined diatomite particles having particles sizes in a range of about 5 microns to less than 45 microns, and from about 10 to about 25 wt % de-dusting agent. The de-dusting agent may include water, and sodium hypochlorite; the sodium hypochlorite may be in the range of at least about 5 ppm to about 500 ppm.

Packaging: Within the diatomite industry, open top bags are not generally used because the porous and buoyant powdered diatomite particles contain entrained air which creates a dusty environment during packaging and portions of such dust may be respirable by workers. By filling the pores of the diatomite with the de-dusting agent, the entrained air issue for open top bags is mitigated, and packaging, such as form fill packaging, that has a completely or substantially open top during filling may be used because the treated diatomite product will generate substantially no dust during filling and is rendered substantially non-respirable/non-respirable.

In one embodiment, a package (e.g., a bag, container, or the like) having a substantially open top may be vertically form-filled with the substantially non-respirable or non-respirable diatomite product. During filling, the open top of the package may be disposed under the spout (and its aperture) through which material flows out of the form filling equipment and into the package. Because the substantially non-respirable or non-respirable diatomite product will generate substantially no dust during the flow into the package, the mouth of the bag does not need to be closely fit around or in contact with the spout. This contrasts with the traditional pasted valve bag where the opening in the bag must be positioned to closely fit over the spout of the spout packer or cover the spout aperture to try to reduce the amount of airborne particles escaping to the surrounding environment during filling.

The package may be subsequently sealed after filling through application of heat to the package. Such thermally-sealed package further prevents the generation of dust that can occur with traditional pasted valve bags (during filling, re-packaging, shipping, transportation, material handling, etc.) because the valve sleeve of the pasted valve bag is simply tucked into the pasted valve bag and such bag is not sealed after filling.

The package used for the substantially non-respirable or non-respirable diatomite product may be re-sealable polymer packaging, for example re-sealable plastic: bags, containers, drums, buckets, jug, pales, or the like. Preferably, the package is fluid-impermeable. For example, in one embodiment, the package is water-impermeable and impermeable to water vapor. In another embodiment, the package is liquid-impermeable (e.g., water-impermeable but permeable to water vapor (may allow for the transmission of water vapor)). In an embodiment, the liquid-impermeable package may be a resealable bag fabricated from at least one synthetic paper. In an embodiment, the package may be fabricated from a polymeric material selected from the group consisting of one or more polyesters, polyamides, polypropylenes, cellophanes, polyvinyl chlorides, polyvinylidene fluorides, polyvinylidene chlorides, polyimides, polyethylene and combinations thereof. In one embodiment, the sealing of the package allows single use. In another embodiment, the sealing of the package allows multiple uses. Furthermore, the polymeric package is durable in wet environments such as pools and spas and, unlike traditional paper bags, the material of the package does not supply food for the growth of micro-organisms inside the package.

In some embodiments, a polymeric package (e.g., a bag) may be used as a precoat slurry preparation container to further eliminate possible exposure of the user to filter medium dust. In some filtration scenarios, a filtration medium is poured into a tank that contains a precoat slurry preparation. The user then adds water to the combination of the precoat slurry preparation and the filtration medium in the tank in order to make a slurry (prior to filtration). While the substantially non-respirable or non-respirable diatomite product generates substantially no dust during agitation, to further eliminate potential opportunities for exposure to dust, water may be added directly to the package described herein to make the precoat slurry in the package.

Different types of packaging materials offer different moisture retention properties. The Moisture Vapor Transmission Rate (MVTR) of a material provides a moisture retention measurement that may be used to compare different packaging materials and compositions of the vapor. For the sake of simplicity, the data referred to below is based on the transmission of water vapor, and some of the transmission rates may vary if other types of liquids/vapors are employed as a de-dusting agent.

MVTR is commonly stated in units of grams of water/100in²/24 hours in the United States and grams of water/m²/24 hours elsewhere. The MVTR is highly dependent on material thickness and the material itself and on the composition of the vapor. The MVTR figures cited here are all for water vapor, and while transmission rates may vary with different types of vapor, the general concept and applicability are the same.

The substantially non-respirable or non-respirable diatomite product (filter medium, additive or the like) is preferably packaged in a material that has low MVTR properties to ensure the product stays hydrated throughout the course of its shelf life. Therefore, using a material to package the product with a low MVTR is more advantageous than using a material with high MVTR properties, since shelf life can be extended. In one embodiment, the package may be made of a material having an MVTR in the range of about 20 g/100 in²/24 hours to about 0 g/100 in²/24 hours (about 20 g/0.065 m²/24 hours to about 0 g/0.065 m²/24 hours). In another embodiment, the package may be made of a material having an MVTR in the range of about 10 g/100 in²/24 hours to about 0 g/100 in²/24 hours (about 10 g/0.065 m²/24 hours to about 0 g/0.065 m²/24 hours). In another embodiment, the package may be made of a material having an MVTR in the range of about 5 g/100 in²/24 hours to about 0 g/100 in²/24 hours (about 5 g/0.065 m²/24 hours to about 0 g/0.065 m²/24 hours). In another embodiment, the package may be made of a material having an MVTR in the range of about 2 g/100 in²/24 hours to about 0 g/100 in²/24 hours (about 2 g/0.065 m²/24 hours to about 0 g/0.065 m²/24 hours). In another embodiment, the package may be made of a material having an MVTR in the range of about 1 g/100 in²/24 hours to about 0 g/100 in²/24 hours (about 1 g/0.065 m²/24 hours to about 0 g/0.065 m²/24 hours). In another embodiment, the package may be made of a material having an MVTR in the range of about 0.5 g/100 in²/24 hours to about 0 g/100 in²/24 hours (about 0.5 g/0.065 m²/24 hours to about 0 g/0.065 m²/24 hours).

The minimum moisture content in the pretreated diatomite product (filter medium, additive or the like) is about 4 wt % de-dusting agent; this level still retains the dust suppression properties. Therefore, the expected shelf life can be determined by using the MVTR as calculated by various standard test methods from the International Organization for Standardization (ISO), the American Society for Testing and Materials (ASTM), the British Standards (BS), and the German Institute for Standardization (DIN). The following ASTM standard test methods may be used to test the MVTR of materials: ASTM F1249-06, ASTM E398-03, ASTM D3079, ASTM D7709, ASTM E96, ASTM F1249, ASTM D3079 is the most preferred method to test, but any of the testing methods described above may be used to determine MVTR of the packaged pretreated diatomite filter medium, depending on the style of packaging.

An exemplary calculation of shelf life of substantially non-respirable/non-respirable diatomite products is shown in Table II. Two exemplary moisture content conditions are shown, one package of substantially non-respirable/non-respirable diatomite product containing 20 wt % de-dusting agent and the other at 75 wt % de-dusting agent. Both exemplary calculations assume the use of a 1429 in² (0.922 m²) package, which is roughly a 24 lb. (10.9 kg) bag. Both calculations also assume about a 4 wt % de-dusting agent lower limit, which determines when the substantially non-respirable/non-respirable diatomite product may possess reduced dust suppression properties. The data shows the difference in shelf life between the products when packaged with different materials.

TABLE II

| | | Shelf Life of 20% | Shelf Life at 75% |
|---|---|---|---|
| | MVTR | Moisture Content | Moisture Content |
| | (g/100 in²/24 hours) | Invention | Invention |
| Packaging Material | [g/100 cm²/24 hrs.] | (days) | (days) |
| Aclar 33C .75 mil (military | 0.04 | 2856 | 13329 |
| grade) | [0.26] | | |
| Saran HB 1 mil | 0.05 | 2285 | 10663 |
| | [0.32] | | |
| Metallized Polyester 48 Ga. | 0.05 | 2285 | 10663 |
| | [0.32] | | |
| Saran 1 mil | 0.20 | 571 | 2666 |
| | [1.29] | | |
| Saranex 142 mil | 0.20 | 571 | 2666 |
| | [1.29] | | |
| Metallized Nylon 48 Ga. | 0.20 | 571 | 2666 |
| | [1.29] | | |
| PVDC-Nylon 1 mil | 0.20 | 571 | 2666 |
| | [1.29] | | |
| 50 M-30 PVDC Coated | 0.40 | 286 | 1333 |
| Polyester | [2.58] | | |
| Opp .9 mil | 0.45 | 254 | 1185 |
| | [2.90] | | |
| 250 K Cello | 0.50 | 229 | 1066 |
| | [3.23] | | |
| LDPE 2 mil | 0.60 | 190 | 889 |
| | [3.87] | | |
| Benzyl H 60 Ga | 0.70 | 163 | 762 |
| | [4.52] | | |
| EVA EF-E 1 mil | 1.40 | 82 | 381 |
| | [9.03] | | |
| Pliofilm 1 mil | 1.70 | 67 | 314 |
| | [10.97] | | |
| EVA, Biax 60 Ga. | 2.60 | 44 | 205 |
| | [16.77] | | |
| Polyester 48 Ga. | 2.80 | 41 | 190 |
| | [18.06] | | |
| 50 M-30 Polyester Film | 2.80 | 41 | 190 |
| | [18.06] | | |
| EVA EF-F 1 mil | 3.80 | 30 | 140 |
| | [24.52] | | |
| Barex 210 1 mil | 4.50 | 25 | 118 |
| | [29.03] | | |
| PVC 1 mil | 4.50 | 25 | 118 |
| | [29.03] | | |
| Polystyrene 1 mil | 7.20 | 16 | 74 |
| | [46.45] | | |
| Polycarbonate 1 mil | 9.00 | 13 | 59 |
| | [58.06] | | |
| Nylon 1 mil | 19.00 | 6 | 28 |
| | [122.58] | | |
| 195 MSBO Cello | 45.00 | 3 | 12 |
| | [290.32] | | |

Examples: Dust and Respirable Portion of Product:

As a proxy measurement for the amount of respirable diatomite, the inventors used optical measurements of the dust generated during standard tests. The amount of dust created or the dustiness of the substantially non-respirable/non-respirable diatomite product may be evaluated with both visual observation and standard industrial methods, such as the use of dust-measuring devices or meters. For example, the dustiness of a sample may be visually evaluated by comparing the dustiness when the substantially non-respirable/non-respirable diatomite product is poured out of a bag, container, or the like, or when the substantially non-respirable/non-respirable diatomite product is discharged from the blender/agitator and poured into a bag, container, or the like.

In contrast, a dust-measuring meter may be employed in the form of a laser detector. The laser detector may be used to detect the level of dustiness when the substantially non-respirable or non-respirable diatomite product is dropped from a predetermined height. A single drop method may be used. As another alternative, a fully automated dust-measuring device, such as a DustView II™ (PALAS®) dust-measuring device, may be employed. The DustView II™ device provides a fast and accurate measurement of airborne particles, which are released after the materials fall and impact a solid floor or foundation. The DustView II™ operates under the principle that the airborne dust reduces light intensity, specifically the transmission of the laser light.

### Example 1

### Qualitative Observations of the Substantially Non-respirable or Non-respirable Diatomite Product Poured into an Open Container

Three samples of the substantially non-respirable or non-respirable diatomite product were prepared. Each sample comprised diatomite (filtration medium, FW-60, from EP Minerals LLC, Reno, Nev.), and a de-dusting agent. The de-dusting agent, in these exemplary embodiments, was deionized water. The first sample included 5% deionized water, the second sample included 10% deionized water and the last sample included 20% deionized water. In each case 300 grams of the sample were prepared by adding the appropriate amount of the de-dusting agent (deionized water) and mixing thoroughly by hand until the resulting product was homogenous. The samples were poured from a container positioned about three feet above the bottom of a drum. Upon impacting the bottom of the drum no dust was visible. Additionally, no dust was observed during the pouring process from the bag to the bottom of the drum.

As a control, untreated diatomite powder was dropped from a similar height and a cloud of dust was visible both when the product hit the bottom of the drum and, prior to striking the bottom of the drum, while the product was being poured through the air, indicating that the pre-treatment rendered the diatomite powder substantially non-respirable or non-respirable.

### Example 2

### Qualitative Observation of Substantially Non-respirable or Non-Respirable Diatomite Product Discharged into Bags

A substantially non-respirable or non-respirable diatomite product was prepared at a pilot scale test. The product comprised diatomite and a de-dusting agent. In this example, the de-dusting agent was water. The product was prepared by processing FW-60 from EP Minerals LLC, Reno, Nev. through a paddle mixer blending and packaging unit at EP Mineral's Lovelock, Nevada operation. For this pilot scale test, 1600 lb. (725.7 kg) of powdered FW-60 (diatomite) was added to the blender and the unit was turned on. While the material was mixing, 400 lb. (181.4 kg) of water was added to the mixture over the course of 20 minutes to produce the substantially non-respirable or non-respirable powdered diatomite product. A second large sample was produced in the same manner by adding 200 lbs. (90.7 kg) of water as the de-dusting agent. Final moisture contents were measured post-production to be 15 wt % and 5 wt %, respectively. During the de-dusting agent addition, the powdered diatomite responded almost immediately with significant dust reduction after only a few minutes of the de-dusting agent addition. No nuisance dust was observed, even as the paddle mixer was vigorously lifting the product through the air. During packaging, the product was discharged from the paddle mixer/blender and poured into bags, and during this process, no dust was visible, indicating that both the product containing 15 wt % moisture and the product containing 5 wt % moisture, while still in a powder form, were both substantially non-respirable or non-respirable.

### Example 3

### Qualitative Observation of Sealing a Bag Containing the Substantially Non-Respirable or Non-Respirable Diatomite Product

A sample of the substantially non-respirable or non-respirable diatomite powder was prepared that comprised a de-dusting agent and diatomite. The de-dusting agent in this sample was deionized water. The sample was prepared by mixing 10% deionized water by weight and 90% diatomite powdered product (FW-60 produced by EP Minerals LLC, Reno, Nev.) by weight. The sample was mixed thoroughly by hand until it was a homogenous powder. This sample was then poured into an open top plastic bag and the bag was then squeezed and closed quickly. No dust was visible during these processes.

In a control experiment, untreated diatomite powder (FW-60) was poured into an open top plastic bag and the bag was then squeezed and closed quickly. A cloud of dust erupted from the bag, indicating that the pre-treatment had made the powdered diatomite product substantially non-respirable or non-respirable.

### Example 4

### Quantitative Test for Use of Propylene Glycol De-Dusting Agent, Using GID Pattern Observation Board

A substantially non-respirable or non-respirable diatomite product was prepared that comprised natural (uncalcined) diatomite and a de-dusting agent. The exemplary de-dusting agent was propylene glycol, a common paint additive. More specifically, the product was prepared by mixing 40 wt % propylene glycol and 60 wt % LCS-3, a natural (uncalcined) diatomite functional additive product produced by EP Minerals LLC, Reno, Nev., thoroughly by hand to produce a homogenous sample. A second sample comprising a flux calcined diatomite and a de-dusting agent was also prepared. In this sample, the de-dusting agent was polyethylene glycol. The sample was prepared by mixing 40 wt % polyethylene glycol and 60 wt % MW-27, a flux calcined diatomite functional additive product produced by EP Minerals LLC, Reno, Nev.

The two samples were poured and tested in a similar manner to Example 1 above and compared to their respective controls, which were not treated with the propylene glycol de-dusting agent. However, for this experiment, a black backboard was constructed to aid in visualizing the dust clouds. Gridlines were added to the backboard with 6 inch (15.2 cm) height horizontal lines and 10 inch (25.4 cm) width vertical lines. In both cases, the untreated control diatomite products produced visible dust throughout the pouring and impact stages, with their respective dust cloud sizes shown in Table III. However, the propylene glycol/diatomite samples were observed to be virtually 100% nuisance dust free during the pouring and impact stages, rendering the product substantially non-respirable or non-respirable and their results are also recorded in Table III. The results show that alternative de-dusting agents (e.g. as propylene glycol or other compatible liquids), which may be required to be compatible with certain functional additive products, such as paint, plastic or rubber fillers, can be mixed with diatomite (e.g. diatomite filtration medium, diatomite additive, or the like) to render the resulting composition substantially non-respirable or non-respirable.

TABLE III
Diatomite Dust Cloud Size Reduction
by Propylene Glycol Addition Sample

| | Dust Cloud Width | Dust Cloud Height |
|---|---|---|
| | inches (cm) | inches (cm) |
| MW-27 EP Minerals Control | 15 (38.1) | 10 (25.4) |
| MW-27 EP Minerals 40 wt % | 0 | 0 |
| Propylene Glycol | | |
| LCS-3 EP Minerals Control | 20 (50.8) | 12 (30.5) |
| LCS-3 EP Minerals 40 wt % | 0 | 0 |
| Propylene Glycol | | |

### Example 5

### Quantitative Results for Substantially Non-Respirable or Non-Respirable Diatomite Product Using DustView II™ Instrument

The results of this experiment, in which the DustView II™ instrument was used, are shown in Table IV. In this experiment, the pre-treatment of diatomite powder with three different levels of de-dusting agent and one control in which no de-dusting agent was added were evaluated. In each case in which a de-dusting agent was added, water was used as the de-dusting agent.

In each case, a 30 g sample of FW-60, which is a flux calcined diatomite product of EP Minerals LLC, Reno, Nev., was used as the starting diatomite material. The tests were completed by placing either the non-respirable/substantially non-respirable diatomite products or the controls into a hopper located adjacent to the top of the instrument and then allowed to free fall and impact at the base of the sample chamber. The level of dust generated, both by the free fall and the impact, was monitored by the DustView II™ instrument during a 30 second interval, which quantified the amount of dust to produce a dust number. The dust number calculated by the Dust View II™ represents a quantitative measurement of the amount of dust generated during the test when dust from the sample is dispersed in the sample chamber. The resulting dust development causes an attenuation of the instrument's laser beam (extinction measurement). This attenuation is observed during measurement and classified as a dust value between 0 and 100. A value of zero (0) means there was no attenuation of the laser beam due to dust development (there was no or very minor dust in the sample chamber). A value of 100 means that there was complete attenuation of the laser beam due to dust development.

TABLE IV
Dustiness Measurements Produced by DustView II ™
Instrument During Example 5.

| Sample | water, wt % | Dust Number |
|---|---|---|
| Control | 0 | 70.00 |
| Sample-1 | 4 | 0.10 |
| Sample-2 | 15 | 0.19 |
| Sample-3 | 26 | 0.18 |

Based on the dust numbers from this test, the pre-treatment of the diatomite product reduced the dust generated during the test by about 99.7 to about 99.9 percent, indicating that the pre-treatment made the diatomite product substantially non-respirable or non-respirable.

TABLE V
Substantially Non-respirable or Non-respirable Diatomite,
Three months incubation bioburden test results measured
by Independent Laboratory Pace Analytical Services Inc.

| | | | Fungi | Aerobic |
|---|---|---|---|---|
| Test | Bag | De-dusting Test | Count | Count |
| # | Condition | Conditions | (CFU/0.1 g) | (CFU/0.1 g) |
| 1 | Closed | Control Sample: No | 0 | 0 |
| | | de-dusting agent | | |
| 2 | Closed | 15% Vale, Oregon, USA | 11 | 114 |
| | | Reverse Osmosis water | | |
| 3 | Closed | 15% Vale, Oregon, USA | Too high to | Too high to |
| | | ground water | count | count |
| 4 | Closed | 15% Vale, Oregon, USA | 0 | 0 |
| | | ground water with 1% | | |
| | | bleach | | |
| 5 | Open | 15% Vale, Oregon, USA | Too high to | Too high to |
| | | ground water | count | count |
| 6 | Open | 15% Vale, Oregon, USA | 0 | 0 |
| | | ground water with 1% | | |
| | | bleach | | |
| 7 | Closed | 15% Reno, Nevada, | 0 | 0 |
| | | USA tap water | | |

As the Table V shows, a substantial growth of fungi and aerobic bacteria can occur in the substantially non-respirable or non-respirable diatomite product and its package (bag), but the growth of bio burden can be prevented or substantially eliminated through the use of reverse osmosis membrane filtration of the de-dusting agent prior to use; the addition of a small amount of bleach, or through the addition of treated municipal water.

### Example 6

### Prevention of Algal Growth in Substantially Non-Respirable or Non-Respirable Powdered Diatomite Product

In some diatomite filtration applications, such as for swimming pool and spa filtration, it is necessary that that the filtration media be free of live algae or algae spores. Such contaminants could cause an unwanted algae blooms in pools and spas. Example 6 shows the results of an experiment conducted to show that algal growth in the substantially non-respirable/non-respirable diatomite product and its package (bag) can be controlled.

In this experiment, a water sample was collected from a local pond with algae present for use as a positive control. Five bottled water samples were purchased and about 50 ml of water was removed from each bottle. Then 10 ml of liquid plant fertilizer was added to each water bottle and 20 ml of pond water was added to the positive control (EP-1). As a negative control, a water bottle with 10 ml of liquid fertilizer was used (EP-2). Then 5 grams of each diatomite sample, in this case FW-60 from EP Minerals LLC, Reno, NV was added to its respective water bottle (EP-3, EP-4, and EP-5). One diatomite control, without any de-dusting agent was used and labelled EP-3. Two other substantially non-respirable/non-respirable diatomite samples were prepared by 20% addition of well water from EP Minerals' Vale Operation's well. One of the substantially non-respirable/non-respirable samples also contained a sanitizing agent, in this case bleach or sodium hypochlorite, at a level of 5 ppm active chlorine.

Carbon dioxide and air were then added to the water bottles. The samples were then allowed to incubate for 1 month in a fume hood provided with 24 hours of artificial light per day. After one month, the samples were sent off for chlorophyll A content analysis, which reveals the presence of any plant life including algae. Results of the experiment are shown below in Table VI.

TABLE VI
Algae/Chlorophyll A Content of Substantially Non-
respirable/Non-respirable Diatomite Product

| | Sample | Chlorophyll A Content |
|---|---|---|
| Sample | Label | (μg/L) |
| Pond Water Positive Control | EP-1 | 47 |
| Bottled Water Negative Control | EP-2 | Non-Detectable (<2) |
| Swim Pool- Un-hydrated | EP-3 | Non-Detectable (<2) |
| Swim Pool- Hydrated no bleach | EP-4 | Non-Detectable (<2) |
| Swim Pool- Hydrated w/bleach | EP-5 | Non-Detectable (<2) |

Note:
Chlorophyll A content was analyzed by Sierra Environmental Monitoring

The results indicated that no algae or algae spores were present in any of the diatomite samples. The samples were allowed to incubate for over 1 month in the presence of light and a food source.

The positive control confirmed the presence of algae, while the negative control confirmed no algae was present, both of which verified the analytical techniques used.

### INDUSTRIAL APPLICABILITY

The diatomite product disclosed herein is pretreated so that it is hygienic, mold free and, at least, substantially dustless and substantially non-respirable or non-respirable during subsequent handling, storage and use. Non-respirable/substantially non-respirable diatomite products disclosed herein are suitable for storage of at least one year and preferably for as long as five years. Non-respirable/substantially non-respirable diatomite filter media products for pools and spas and traditional food, beverage and chemical filtrations and non-respirable diatomite products such as functional additives are disclosed. The disclosed methods utilize at least one de-dusting agent that dramatically reduces or eliminates diatomite dust and thus renders the diatomite product substantially non-respirable or non-respirable. This is beneficial during material handling practices such as packaging, re-packaging, shipping, and transportation of such non-respirable/substantially non-respirable diatomite product (e.g., filter medium), as well as during the use of the pretreated diatomite product in liquid systems, such as those for filtration of swimming pools and spas and in other traditional applications of diatomite filtration media, as well as additives in coatings, paper and selected structural products. Further, these benefits are achieved without reducing the performance of such diatomite products.

1. A method for manufacturing a low dust diatomaceous earth filter medium, the method comprising:
calcining diatomite to provide calcined diatomite particles having median particle size of 30 to 60 microns;
classifying the calcined diatomite powder to provide the diatomite filter medium;
fluidizing the diatomite filter medium and spraying water onto the diatomite filter medium during fluidization of the diatomite filter medium to provide a pretreated diatomite filter medium; and
packaging the pretreated diatomite filter medium in a water-impermeable package.

2. The method of claim 1 further comprising spraying an antimicrobial agent onto the diatomite filter medium during fluidization of the diatomite filter medium, the antimicrobial agent selected from the group consisting of chlorine dioxide, sodium hypochlorite, calcium hypochlorite, sodium dichloroisocyanurate, and mixtures thereof.

3. A method for manufacturing low dust, pretreated diatomite filter medium, the method comprising:
calcining natural diatomite powder in the presence of a flux to provide flux calcined diatomite powder having particles of a median particle size in the range of about 20 microns to about 60 microns;
classifying the flux calcined diatomite powder to provide diatomite filter medium;
fluidizing the diatomite filter medium and spraying a de-dusting agent onto the diatomite filter medium during fluidization of the diatomite filter medium to provide the pretreated diatomite filter medium; and
packaging the pretreated diatomite filter medium in a water-impermeable package, wherein the de-dusting agent includes water.

4. The method of claim 1, wherein the package is a bag fabricated from at least one polymeric material selected from the group consisting of one or more polyesters, polyamides, polypropylenes, cellophanes, polyvinyl chlorides, polyvinylidene fluorides, polyvinylidene chlorides, polyimides, and polyethylenes, and combinations thereof.

5. The method of claim 1, in which the packaging includes vertically filling the package and thermally sealing the package.

6. The method of claim 3, wherein the de-dusting agent further includes an antimicrobial agent selected from the group consisting of chlorine dioxide, sodium hypochlorite, calcium hypochlorite, sodium dichloroisocyanurate, and mixtures thereof.

7. A packaged product comprising natural, calcined or flux calcined diatomite having a median particle size distribution between about 10 microns and about 60 microns,
wherein the product is substantially non-respirable, has a dust number less than about 0.2, and is enclosed inside a package,
wherein the product and the inside of the package have, in aggregate, an aerobic bacterial count between about zero and about 114 (CFU/0.1 g).

8. The product of claim 7 further comprising between about 4 wt % and about 70 wt % de-dusting agent.

9. The product of claim 8, wherein the de-dusting agent is water.

10. The product of claim 8, wherein the product is a filter medium or a functional additive for a target liquid in a liquid system, and the de-dusting agent is compatible in the liquid system with the target liquid.

11. The product of claim 8, wherein the de-dusting agent is a liquid and the package is a bag that is impermeable to the de-dusting agent.

12. The product of claim 8, in which the de-dusting agent includes water and about 5 ppm to about 500 ppm sodium hypochlorite.

13. A method comprising using the product of claim 7 in a filtration or a functional additive application.

14. The product of claim 13 in which the bag is made of a material having an MVTR in the range of about 20 g/0.065 m²/24 hours to about 0 g/0.065 m²/24 hours, as determined by using a standard test method selected from the group consisting of ASTM F1249-06, ASTM E398-03, ASTM D3079, ASTM D7709, ASTM E96, and ASTM F1249.

15. The product of claim 7, wherein the product has a Chlorophyll A content that is less than about 47 (μg/L).

16. The product of claim 7, wherein the product has a Chlorophyll A content that is between about zero and about 2 (μg/L).

17. The method of claim 3, wherein the package is a bag fabricated from at least one polymeric material selected from the group consisting of one or more polyesters, polyamides, polypropylenes, cellophanes, polyvinyl chlorides, polyvinylidene fluorides, polyvinylidene chlorides, polyimides, polyethylenes, and combinations thereof.

18. The method of claim 3, in which the packaging includes vertically filling the package and thermally sealing the package.
